(19) United States
(12) Patent Application Publication
(10) Pub. No.: US 2026/0034848 A1
(43) Pub. Date: Feb. 5, 2026

(54) TEMPERATURE ADJUSTMENT SYSTEM FOR ELECTRIC VEHICLE

(71) Applicant: Mazda Motor Corporation, Hiroshima (JP)

(72) Inventors: Shoko Horibata, Aki-gun (JP); Yuma Miyauchi, Aki-gun (JP)

(21) Appl. No.: 19/266,507

(22) Filed: Jul. 11, 2025

(30) Foreign Application Priority Data
Jul. 31, 2024 (JP) 2024-124225

(51) Int. Cl. B60H 1/00; B60H 1/32

(52) U.S. Cl. CPC B60H 1/00278; B60H 1/00392; B60H 1/3217; B60H 1/3219; B60H 1/323; B60H 2001/00928

(57) ABSTRACT

A temperature adjustment system for an electric vehicle includes: a compressor for compressing a CO₂ coolant; a first heat exchanger for cooling the coolant compressed by the compressor; cooling expansion valves for expanding the coolant cooled by the first heat exchanger; a coolant passage for supplying the coolant expanded by the cooling expansion valve to an air conditioner when cooling the air; a coolant passage for supplying the coolant expanded by the cooling expansion valves to a motor when cooling the motor; a common rail and an injector for expanding and injecting the coolant into a battery case; coolant passages for supplying the coolant after cooling the air conditioner to the common rail and the injector when cooling the air conditioner and cooling a battery; and coolant passages for supplying the coolant that has passed through the air conditioner, the motor, and the battery to the compressor.

### TECHNICAL FIELD

The present disclosure relates to a temperature adjustment system for an electric vehicle.

### BACKGROUND ART

Conventionally, an air conditioning system having a thermal cycle circuit that operates with a coolant containing CO₂ (hereinafter referred to as the “CO₂ coolant” as appropriate) has been known. Moreover, a technology that thermally couples a thermal cycle circuit of a vehicle-cabin air conditioning system of an electric vehicle with a battery to cool or heat the battery (for example, Japanese Unexamined Patent Application Publication No. 2011-68348), and a cooling system that directly cools a vehicle drive motor, an inverter, and a battery sealed in individual packages in a cooling unit by circulating low-temperature CO₂ therein (for example, Japanese Unexamined Patent Application Publication No. 2009-107453), are being considered.

### SUMMARY

### Problems to be Solved

In recent years, the use of a CO₂ coolant for a vehicle-cabin air conditioning system is also being considered. In this case, it is conceivable that the CO₂ coolant used in the thermal cycle circuit of the vehicle-cabin air conditioning system may also be used for the temperature adjustment of the motor and the battery.

However, in general, the CO₂ coolant, whose pressure and temperature have been reduced by an expansion valve in the thermal cycle circuit of the air conditioning system, still has an extremely high pressure of about 5 MPa, and, if such a high-pressure CO₂ coolant is passed around a cell of the battery to cool the cell directly, it is necessary to strengthen the structures of the battery case and cell, which will increase the weight of the battery and raise manufacturing costs. On the other hand, in a case when the high-pressure CO₂ coolant is circulated through a heat exchanger provided on the outside of the battery case to indirectly cool the cell inside the battery through the heat exchanger, the responsiveness of temperature control is slower compared to direct cooling, and, consequently, the range of battery temperature fluctuation increases, and battery deterioration due to the thermal cycle is more likely to occur.

The present disclosure has been made to solve such problems, and the purpose of the present disclosure is to provide a temperature adjustment system for an electric vehicle that can adjust the temperature of a battery with high responsiveness by the same CO₂ coolant as the CO₂ coolant used for air-conditioning a vehicle cabin.

### Means for Solving The Problems

In order to solve the problems, the present disclosure provides a temperature adjustment system for an electric vehicle including an air conditioning unit for performing air conditioning, a drive motor, and a battery having a cell accommodated in a battery case, the temperature adjustment system including: a compressor for compressing a coolant containing CO₂; a first heat exchanger for cooling the coolant compressed by the compressor; a first expansion valve for expanding the coolant cooled by the first heat exchanger; an air-conditioning cooling path for supplying the coolant expanded by the first expansion valve to the air conditioning unit when cooling the air conditioning unit; a motor cooling path for supplying the coolant expanded by the first expansion valve to the motor when cooling the motor; a second expansion valve for expanding and injecting the coolant into the battery case; a first battery cooling path for supplying the coolant after cooling the air conditioning unit to the second expansion valve when cooling the air conditioning unit and cooling the battery; and a recovery path for supplying, to the compressor, the coolant that has passed through the air conditioning unit, the coolant that has passed through the motor, and the coolant that has passed through the battery.

According to the present disclosure thus configured, since the cooling of the air conditioning unit, the cooling of the motor, and the cooling of the battery are performed using a shared coolant containing CO₂, the overall configuration of the temperature adjustment system can be made compact. Moreover, when cooling the air conditioning unit and cooling the battery, since the coolant after cooling the air conditioning unit is supplied to the second expansion valve and further expanded and injected into the battery case from the second expansion valve, it is possible to directly cool the cell with the coolant while maintaining the strength of the structures of the cell and the case of the battery at about the same level as before. Consequently, it is possible to perform the temperature adjustment of the battery with high responsiveness, without causing an increase in the weight of the battery or a rise in manufacturing costs.

In the present disclosure, the compressor preferably includes a first compressor for compressing the coolant that has passed through the battery, and a second compressor for compressing the coolant that has passed through the air conditioning unit and the coolant that has passed through the motor, and the second compressor further compresses the coolant, which has been compressed by the first compressor, when cooling the air conditioning unit and cooling the battery.

According to the present disclosure thus configured, since the coolant that has been compressed by the first compressor after passing through the battery, the coolant that has passed through the air conditioning unit, and the coolant that has passed through the motor can all be compressed by the second compressor, the second compressor can be shared to compress the coolant used for cooling the air conditioning unit, the motor, and the battery, and the overall configuration of the temperature adjustment system can be made compact.

In the present disclosure, the temperature adjustment system for the electric vehicle preferably includes a battery heating path for supplying the coolant compressed by the first compressor to the second expansion valve when heating the battery.

According to the present disclosure thus configured, it is possible to directly heat the cell with the coolant by expanding and injecting the high-temperature, high-pressure coolant compressed by the first compressor into the battery case from the second expansion valve. Consequently, it is possible to perform the temperature adjustment of the battery with high responsiveness, without causing the increase in the weight of the battery or the rise in manufacturing costs.

In the present disclosure, the temperature adjustment system for the electric vehicle preferably includes: a second heat exchanger that, when cooling the battery when the air conditioning unit is heating or off, cools the coolant compressed by the first compressor; and a second battery cooling path that, when cooling the battery when the air conditioning unit is heating or off, supplies the coolant cooled by the second heat exchanger to the second expansion valve.

According to the present disclosure thus configured, since the coolant that has passed through the battery is compressed by the first compressor, further cooled by the second heat exchanger and then supplied to the second expansion valve via the second battery cooling path, and expanded and injected into the battery case from the second expansion valve, it is possible to directly cool the cell with the coolant flowing through a thermal cycle circuit independent of the air conditioning unit even when the air conditioning unit is heating or off and the coolant after cooling the air conditioning unit cannot be used. Consequently, it is possible to perform the temperature adjustment of the battery with high responsiveness, without causing an increase in the weight of the battery or a rise in manufacturing costs.

In the present disclosure, the second expansion valve preferably has a common rail for accumulating the coolant, and an injector for injecting the coolant accumulated in the common rail into the battery case.

According to the present disclosure thus configured, since a necessary amount of the coolant according to the heat generation amount and temperature of the battery can be highly accurately injected at an appropriate pressure into the battery case from the injector, it is possible to curb temperature fluctuations of the cell of the battery and reduce deterioration of the battery due to thermal cycles.

In the present disclosure, the temperature adjustment system for the electric vehicle preferably includes an air-conditioning heating path for supplying the coolant compressed by the compressor to the air conditioning unit when heating the air conditioning unit.

According to the present disclosure thus configured, it is possible to heat the air conditioning unit by supplying the high-temperature, high-pressure coolant compressed by the compressor to the air conditioning unit via the air-conditioning heating path.

### Advantageous Effects

According to the temperature adjustment system for the electric vehicle of the present disclosure, the temperature of the battery can be adjusted with high responsiveness using a CO2 coolant that is also used for air conditioning the vehicle cabin.

### BRIEF DESCRIPTION OF DRAWINGS

FIG. 1 is a schematic configuration diagram of a vehicle to which a temperature adjustment system for an electric vehicle according to an embodiment of the present disclosure is applied.

FIG. 2 is a schematic configuration diagram of the temperature adjustment system for the electric vehicle according to the embodiment of the present disclosure.

FIG. 3 is a block diagram showing an electrical configuration of the temperature adjustment system for the electric vehicle according to the embodiment of the present disclosure.

FIG. 4 is a flowchart of control to be executed by the temperature adjustment system for the electric vehicle according to the embodiment of the present disclosure.

FIG. 5 is a table showing air-conditioning/battery coordinated control patterns corresponding to combinations of air conditioning requests and battery temperature adjustment requests in the temperature adjustment system for the electric vehicle according to the embodiment of the present disclosure.

FIG. 6 is an explanatory view showing the pressure-enthalpy (P-H) diagram and pressure-temperature (P-T) diagram of the thermal cycles of an air conditioner and a battery, and the flow of coolant in an air-conditioning/battery coordinated control pattern 1-a of the temperature adjustment system for the electric vehicle according to the embodiment of the present disclosure.

FIG. 7 is an explanatory view showing the P-H diagram and P-T diagram of the thermal cycles of the air conditioner and the battery, and the flow of coolant in an air-conditioning/battery coordinated control pattern 2-a of the temperature adjustment system for the electric vehicle according to the embodiment of the present disclosure.

FIG. 8 is an explanatory view showing the P-H diagram and P-T diagram of thermal cycles of the air conditioner and the battery, and the flow of coolant in an air-conditioning/battery coordinated control pattern 2-b of the temperature adjustment system for the electric vehicle according to the embodiment of the present disclosure.

FIG. 9 is an explanatory view showing the P-H diagram and P-T diagram of the thermal cycle of the battery, and the flow of coolant in an air-conditioning/battery coordinated control pattern 3-a of the temperature adjustment system for the electric vehicle according to the embodiment of the present disclosure.

FIG. 10 is an explanatory view showing the P-H diagram and P-T diagram of the thermal cycle of the battery, and the flow of coolant in an air-conditioning/battery coordinated control pattern 3-b of the temperature adjustment system for the electric vehicle according to the embodiment of the present disclosure.

FIG. 11 is an explanatory view showing the P-H diagram and P-T diagram of the thermal cycles of the air conditioner and the battery, and the flow of coolant in an air-conditioning/battery coordinated control pattern 4-a of the temperature adjustment system for the electric vehicle according to the embodiment of the present disclosure.

FIG. 12 is an explanatory view showing the P-H diagram and P-T diagram of the thermal cycles of the air conditioner and the battery, and the flow of coolant in an air-conditioning/battery coordinated control pattern 4-b of the temperature adjustment system for the electric vehicle according to the embodiment of the present disclosure.

### DETAILED DESCRIPTION

Hereinafter, a temperature adjustment system for an electric vehicle according to an embodiment of the present disclosure will be described with reference to the attached drawings.

### Overall Configuration

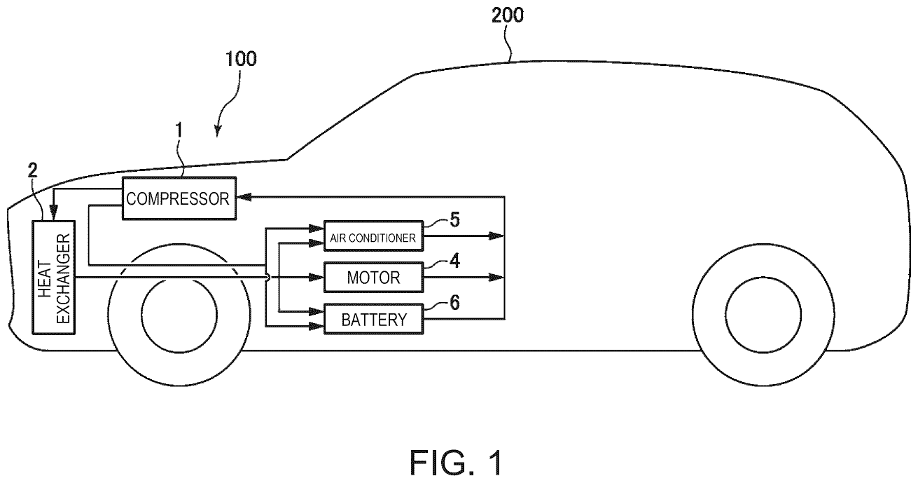

First, the overall configuration of the temperature adjustment system for the electric vehicle according to the present embodiment will be described with reference to FIG. 1. FIG. 1 is a schematic configuration diagram of a vehicle to which the temperature adjustment system for the electric vehicle according to the present embodiment is applied.

As shown in FIG. 1, an electric vehicle 200 has: a temperature adjustment system 100 with a thermal cycle circuit that operates with a coolant containing CO₂; a motor 4 for driving the electric vehicle 200; an air conditioner 5 (example of an air conditioning unit) for conditioning air in the electric vehicle 200; and a battery 6 for supplying electric power to the motor 4. Moreover, the temperature adjustment system 100 mainly includes a compressor 1 for compressing the coolant, and a heat exchanger 2 for cooling the coolant that has been compressed by the compressor 1.

The temperature adjustment system 100 circulates a CO₂ coolant (hereinafter simply referred to as the “coolant”) that is a natural coolant. Typically, the CO₂ coolant is a coolant obtained by causing CO₂ to contain refrigerant oil such as polyalkylene glycol (PAG) and additives. In order to use such a CO₂ coolant, the compressor 1 is configured to compress the coolant to a very high pressure. The motor 4 uses the coolant, which has been compressed by the compressor 1 and cooled by the heat exchanger 2, to cool a rotor and a stator. Further, the motor 4 is configured such that a sliding bearing supporting a rotating shaft is lubricated by the coolant. Furthermore, the coolant that has been compressed by the compressor 1, or the coolant that has been compressed and then cooled by the heat exchanger 2, is used for air conditioning in the air conditioner 5, and for cooling or heating the battery 6.

### Configuration of Temperature Adjustment System

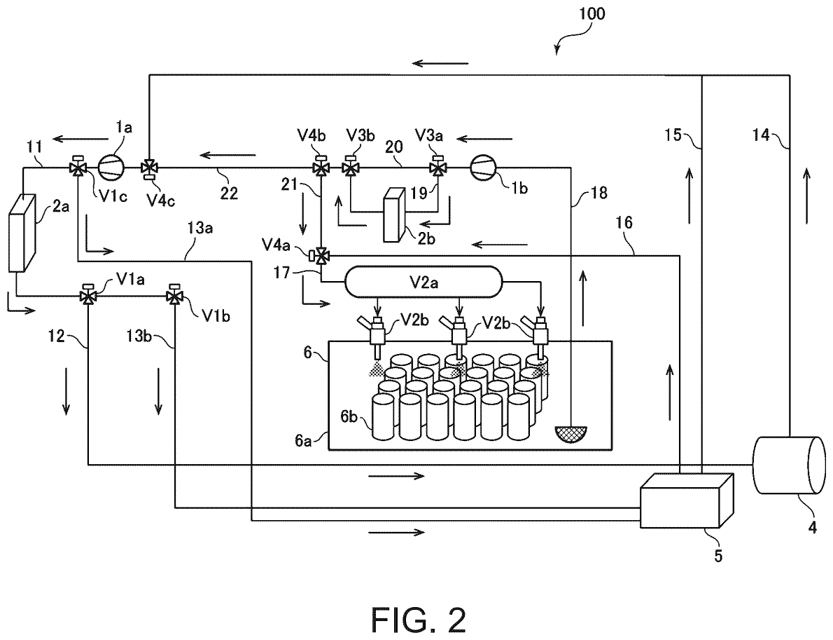

Next, the temperature adjustment system 100 according to the present embodiment will be specifically described with reference to FIG. 2. FIG. 2 is a schematic configuration diagram of the temperature adjustment system 100 according to the present embodiment.

The temperature adjustment system 100 constitutes a thermal cycle circuit for circulating the CO₂ coolant, and includes, in addition to the compressor 1 and the heat exchanger 2, coolant passages 11 to 22 through which the coolant flows, cooling expansion valves V1a, V1b (examples of first expansion valves) for expanding the coolant to reduce the pressure, a common rail V2a, injectors V2b, a temperature-increasing valve V1c, heat exchanger bypass control valves V3a, V3b and low-pressure coolant switching control valves V4a, V4b, V4c for switching the coolant passages.

In the present embodiment, the compressor 1 includes: a high-pressure compressor 1a (example of a second compressor) for compressing the coolant that has passed through the air conditioner 5 and the coolant that has passed through the motor 4; and a low-pressure compressor 1b (example of a first compressor) for compressing the coolant that has passed through the battery 6. The high-pressure compressor 1a increases a first pressure of the coolant to a second pressure that is greater than the first pressure, and the low-pressure compressor 1b increases a third pressure of the coolant to the first pressure, where the first pressure is greater than the third pressure. In one example, the second pressure is about 11 MPa, the first pressure is about 5 MPa or 2 MPa, and the third pressure is about 0.1 MPa.

The heat exchanger 2 includes: a first heat exchanger 2a that cools the coolant compressed by the high-pressure compressor 1a; and a second heat exchanger 2b that, when cooling the battery 6 when the air conditioner 5 is heating or off, cools the coolant compressed by the low-pressure compressor 1b.

The motor 4 is cooled by the temperature adjustment system 100. Specifically, the coolant is compressed by the high-pressure compressor 1a, cooled by passing through the first heat exchanger 2a via the coolant passage 11, further becomes a lower temperature by being expanded by the cooling expansion valve V1a, and is then supplied from the coolant passage 12 (example of a motor cooling path) to the motor 4. The coolant supplied to the motor 4 cools the motor 4 by absorbing heat while passing through the stator, rotor, and bearings of the motor 4, returns to the high-pressure compressor 1a through the coolant passage 14 (example of a recovery path) and the low-pressure coolant switching control valve V4c, and is compressed again.

The air conditioner 5 is cooled or heated by the temperature adjustment system 100. When cooling the air conditioner 5, the coolant is compressed by the high-pressure compressor 1a, cooled by passing through the first heat exchanger 2a via the coolant passage 11, further expanded by the cooling expansion valve V1b to a lower temperature than the air in a vehicle cabin, and then supplied from the coolant passage 13b (example of an air-conditioning cooling path) to the air conditioner 5. The coolant supplied to the air conditioner 5 cools the air flowing into the vehicle cabin by absorbing heat while passing through an in-cabin heat exchanger of the air conditioner 5, returns to the high-pressure compressor la through the coolant passage 15 (example of the recovery path) and the low-pressure coolant switching control valve V4c, and is compressed again. Furthermore, when cooling the battery 6, the coolant that has passed through the air conditioner 5 is supplied from the coolant passage 16 to the battery 6.

When heating the air conditioner 5, the coolant is compressed by the high-pressure compressor 1a and expanded by the temperature-increasing valve V1c, and the coolant having a higher temperature than the air in the vehicle cabin is supplied from a coolant passage 13a (example of the air-conditioning heating path) to the air conditioner 5. The coolant supplied to the air conditioner 5 dissipates heat while passing through the in-cabin heat exchanger of the air conditioner 5 to heat the air flowing into the vehicle cabin, and then returns to the high-pressure compressor 1a through the coolant passage 15 and the low-pressure coolant switching control valve V4c, and is compressed again.

In the present embodiment, the battery 6 has a battery case 6a, and cells 6b accommodated in the battery case 6a. The battery case 6a is sealed, and configured to allow the coolant to flow in and out of the battery case 6a only through the injectors V2b and the coolant passage 18. The common rail V2a and the injectors V2b constitute an expansion valve (example of a second expansion valve) for expanding and injecting the coolant into the battery case 6a.

When cooling the air conditioner 5 and cooling the battery 6, the coolant after cooling the air conditioner 5 is supplied to the common rail V2a via the coolant passage 16, the low-pressure coolant switching control valve V4a and the coolant passage 17 (example of a first battery cooling path). The coolant that has been pressure-accumulated in the common rail V2a is injected into the battery case 6a by the injectors V2b under the control of a control device 40 described later. At this time, the coolant is expanded to a lower temperature than the cells 6b, and the coolant that is injected into the battery case 6a cools the cells 6b by absorbing heat while flowing around the cells 6b, and then flows out of the battery case 6a through the coolant passage 18. Thus, the cells 6b are directly cooled by the coolant. Thereafter, the coolant is compressed by the low-pressure compressor 1b, returns to the high-pressure compressor la through the heat exchanger bypass control valve V3a, the coolant passage 20, the heat exchanger bypass control valve V3b, the low-pressure coolant switching control valve V4b, the coolant passage 22 (example of the recovery path) and the low-pressure coolant switching control valve V4c, and is compressed again.

When cooling the battery 6 when the air conditioner 5 is heating or off, the coolant is not supplied from the air conditioner 5. In this case, the coolant is compressed by the low-pressure compressor 1b, cooled by passing through the second heat exchanger 2b via the heat exchanger bypass control valve V3a and the coolant passage 19, and further supplied to the common rail V2a through the heat exchanger bypass control valve V3b, the low-pressure coolant switching control valve V4b, the coolant passage 21, the low-pressure coolant switching control valve V4a, and the coolant passage 17 (example of a second battery cooling path). The coolant that has been pressure-accumulated in the common rail V2a is injected into the battery case 6a by the injectors V2b, cools the cells 6b by absorbing heat while flowing around the cells 6b, returns to the low-pressure compressor 1b through the coolant passage 18, and is compressed again.

Moreover, when heating the battery 6, the coolant is also not supplied from the air conditioner 5. In this case, the coolant is compressed by the low-pressure compressor 1b, and supplied to the common rail V2a through the heat exchanger bypass control valve V3b, the coolant passage 20, the heat exchanger bypass control valve V3b, the low-pressure coolant switching control valve V4b, the coolant passage 21, the low-pressure coolant switching control valve V4a, and the coolant passage 17 (example of a battery heating path). The coolant that has been pressure-accumulated in the common rail V2a is injected into the battery case 6a by the injectors V2b. At this time, the coolant expands and becomes higher in temperature than the cells 6b, and the coolant that is injected into the battery case 6a dissipates heat while flowing around the cells 6b to heat the cells 6b, and then returns to the low-pressure compressor 1b through the coolant passage 18, and is compressed again. Thus, the cells 6b are directly heated by the coolant.

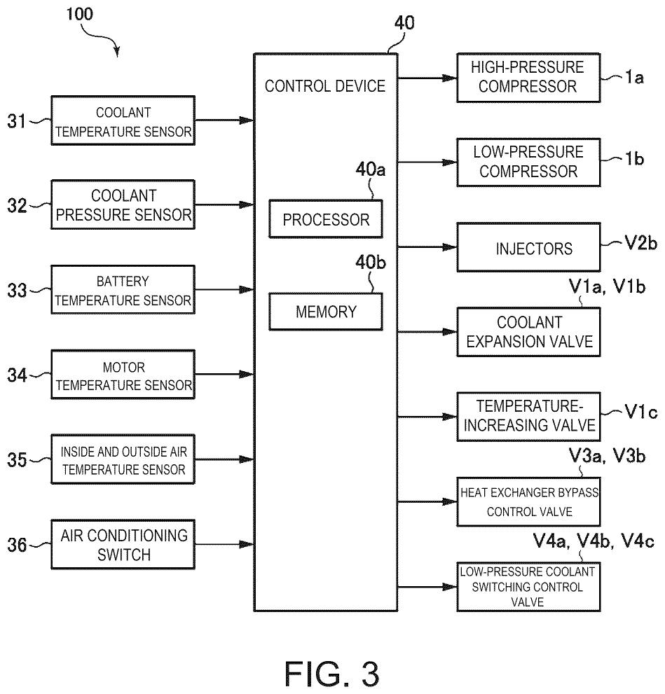

Next, an electrical configuration of the temperature adjustment system 100 according to the present embodiment will be described with reference to FIG. 2 and FIG. 3. FIG. 3 is a block diagram showing the electrical configuration of the temperature adjustment system 100 according to the present embodiment.

As shown in FIG. 3, the temperature adjustment system 100 has the control device 40 configured to perform various kinds of control for the system. The control device 40 is configured with a computer including at least one processor 40a (typically a Central Processing Unit (CPU)), and memory 40b such as Read-Only Memory (ROM) or Random Access Memory (RAM) for storing various kinds of programs that are interpreted and executed on the processor 40a (including basic control programs such as an Operating System (OS), and application programs that are activated on the OS to realize specific functions), and various data.

Moreover, the temperature adjustment system 100 includes: a coolant temperature sensor 31 for detecting the temperature of the coolant flowing through the coolant passages 11 to 22; a coolant pressure sensor 32 for detecting the pressure of the coolant; a battery temperature sensor 33 for detecting the temperature of the battery 6; a motor temperature sensor 34 for detecting the temperature of the motor 4; an inside and outside air temperature sensor 35 for detecting the air temperatures inside and outside the vehicle cabin of the electric vehicle 200; and an air conditioning switch 36 that accepts an operation input to the air conditioner 5. A plurality of coolant temperature sensors 31 and a plurality of coolant pressure sensors 32 can be provided at any location in the coolant passages 11 to 22.

The control device 40 outputs, based on signals input from the sensors 31 to 35 and the air conditioning switch 36, control signals to control the high-pressure compressor 1a, the low-pressure compressor 1b, the injectors V2b, the cooling expansion valves V1a, V1b, the temperature-increasing valve V1c, the heat exchanger bypass control valves V3a, V3b, and low-pressure coolant switching control valves V4a, V4b, V4c.

### Control

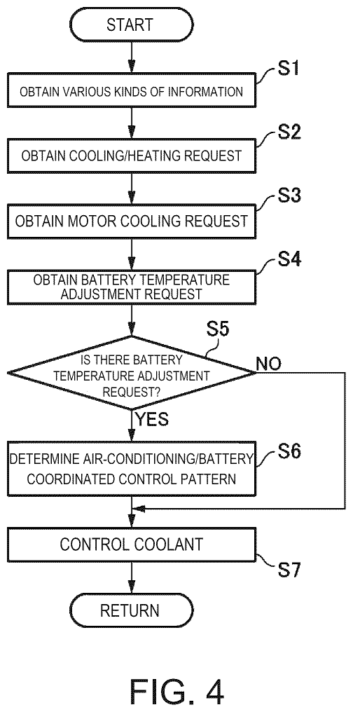

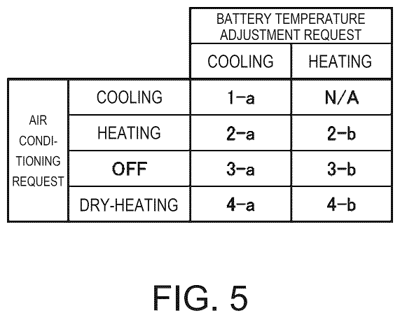

Next, the control that is performed by the control device 40 in the present embodiment will be described with reference to FIG. 4 and FIG. 5. FIG. 4 is a flowchart of the control that is executed by the temperature adjustment system 100 for the electric vehicle 200 according to the embodiment of the present disclosure, and FIG. 5 is a table showing air-conditioning/battery coordinated control patterns corresponding to combinations of air conditioning requests and battery temperature adjustment requests in the temperature adjustment system 100 for the electric vehicle 200.

The control shown in FIG. 4 is repeatedly executed at a predetermined cycle by the control device 40. Specifically, the processor 40a in the control device 40 reads a program stored in the memory 40b, and executes the program, thereby implementing the control shown in the flowchart of FIG. 4.

When the control is started, in step S1, the control device 40 obtains various kinds of information, such as detected values detected by the sensors 31 to 35 and an operation value input to the air conditioning switch 36.

Next, in step S2, the control device 40 obtains, based on the information obtained in step S1, a cooling/heating request for the air conditioner 5, that is, a required value for a cooling capability or a heating capability for the air conditioner 5 (for example, a flow rate of the coolant to be supplied to the air conditioner 5). For example, the required value for the cooling capability or heating capability for the air conditioner 5 is obtained according to the difference between a temperature set by the air conditioning switch 36 and the temperature in the vehicle cabin.

Next, in step S3, the control device 40 obtains, based on the information obtained in step S1, a cooling request for the motor 4, that is, a required value for a cooling capability for the motor 4 (for example, a flow rate of the coolant to be supplied to the motor 4). For example, the required value for the cooling capability for the motor 4 is obtained depending on the difference between a preset reference temperature and the temperature of the motor 4 detected by the motor temperature sensor 34.

Next, in step S4, the control device 40 obtains, based on the information obtained in step S1, a temperature adjustment request for the battery 6, that is, a cooling request or a heating request for the battery 6. Specifically, in a situation in which the battery 6 needs to be cooled, for example, a situation in which electric power is supplied from the battery 6 to drive the motor 4 or a situation in which regenerative electric power is supplied from the motor 4 to the battery 6, when a rise in temperature of the battery 6 is predicted, the control device 40 obtains a required value for a cooling capability for the battery 6 (for example, the injection amount of coolant to be injected from the injectors V2b) depending on the magnitude of power supply output from the battery 6 and the magnitude of the regenerative electric power input to the battery 6. Moreover, in a situation in which the battery 6 needs to be heated, for example, a situation in which it is necessary to raise the temperature of the battery 6 to a charging temperature higher than a normal temperature to allow the electric vehicle 200 to perform charging while stopped, or a situation in which the temperature of the battery 6 detected by the battery temperature sensor 33 while the electric vehicle 200 is traveling is lower than the preset reference temperature, a required value for a heating capability for the battery 6 (for example, the injection amount of coolant to be injected from the injectors V2b) is obtained.

Next, in step S5, the control device 40 determines whether or not there is a temperature adjustment request for the battery 6 in step S4. As a result, when a temperature adjustment request for the battery 6 is obtained (step S5: YES), that is, when the required value for the cooling capability or the heating capability for the battery 6 is obtained in step S4, the control device 40 proceeds to step S6, and determines an air-conditioning/battery coordinated control pattern. In the present embodiment, the air-conditioning/battery coordinated control pattern represents a control pattern of the temperature adjustment system 100 corresponding to a combination of the cooling/heating request for the air conditioner 5 and the temperature adjustment request for the battery 6. For example, a table of the air-conditioning/battery coordinated control patterns as shown in FIG. 5 is stored in the memory 40b in advance. The contents of the control patterns 1-a, 2-a, 2-b, 3-a, 3-b, 4-a, and 4-b shown in the table of FIG. 5 will be described later. The control device 40 obtains, from the memory 40b, the air-conditioning/battery coordinated control pattern corresponding to the cooling/heating request for the air conditioner 5 obtained in step S2 and the temperature adjustment request for the battery 6 obtained in step S4.

After the air-conditioning/battery coordinated control pattern is determined in step S6, or when it is determined in step S5 that there is no temperature adjustment request for the battery 6 in step S4 (in other words, neither cooling nor heating of the battery 6 is required) (step S5: NO), the control device 40 controls the coolant flowing through the temperature adjustment system 100 in step S7, based on the cooling/heating request for the air conditioner 5 obtained in step S2, the cooling request for the motor 4 obtained in step S3, the temperature adjustment request for the battery 6 obtained in step S4, and the air-conditioning/battery coordinated control pattern determined in step S6 if there is a temperature adjustment request for the battery 6 (step S7). In other words, the operations of the high-pressure compressor 1a, the low-pressure compressor 1b, the injectors V2b, the cooling expansion valves V1a, V1b, the temperature-increasing valve V1c, the heat exchanger bypass control valves V3a, V3b, and the low-pressure coolant switching control valves V4a, V4b, V4c are controlled to correspond to each of the required value for the cooling capability or the heating capability for the air conditioner 5, the required value for the cooling capability for the motor 4, the required value for the cooling capability or the heating capability for the battery 6, and the air-conditioning/battery coordinated control pattern. After step S7, the control device 40 ends the control.

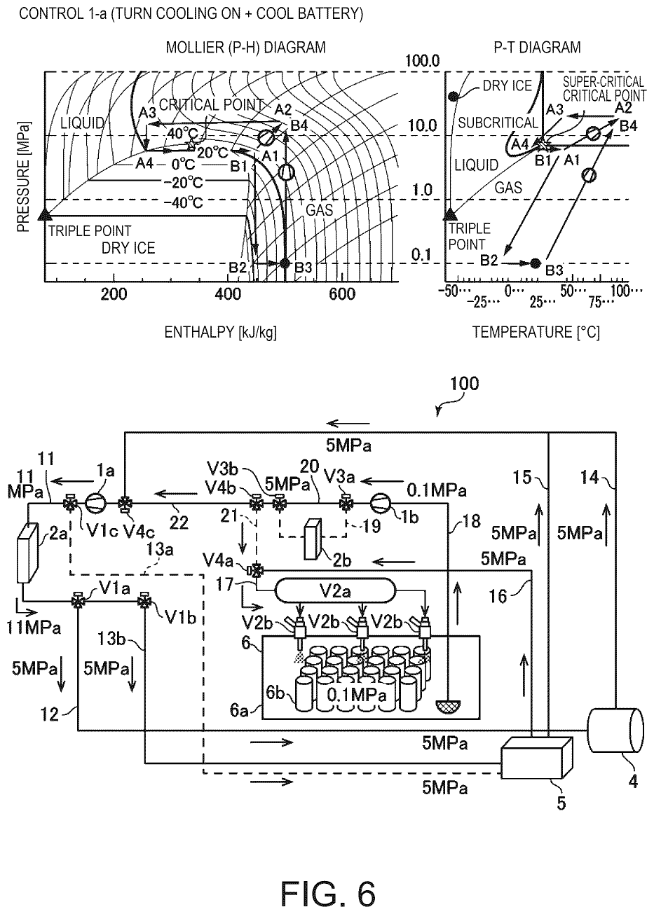

Next, the contents of the respective control patterns 1-a, 2-a, 2-b, 3-a, 3-b, 4-a, and 4-b shown in the table of FIG. 5 will be described with reference to FIG. 6 to FIG. 12. The upper side of each of FIG. 6 to FIG. 12 shows the pressure-enthalpy (P-H) diagram and pressure-temperature (P-T) diagram of cooling or heating cycles of the air conditioner 5 and the battery 6 in each control pattern, and the lower side shows a thermal cycle circuit of the temperature adjustment system 100 in each control pattern. In the thermal cycle circuits of FIG. 6 to FIG. 12, the solid lines indicate coolant passages through which the coolant flows, and the dashed lines indicate coolant passages through which the coolant does not flow.

### Air-Conditioning/Battery Coordinated Control Pattern 1-a

FIG. 6 is an explanatory view showing the P-H diagram and P-T diagram of the cooling cycles of the air conditioner 5 and the battery 6, and the flow of the coolant in the air-conditioning/battery coordinated control pattern 1-a. As shown in FIG. 5, the air-conditioning/battery coordinated control pattern 1-a is an example of a control pattern when there are a cooling request for the air conditioner 5 and a cooling request for the battery 6.

In the air-conditioning/battery coordinated control pattern 1-a, as shown in FIG. 6, a thermal cycle circuit for cooling the motor 4, a thermal cycle circuit for performing cooling by the air conditioner 5, and a thermal cycle circuit for cooling the battery 6 using the coolant after cooling the air conditioner 5 are formed in the temperature adjustment system 100.

Of these thermal cycle circuits, in the thermal cycle circuit for cooling the motor 4, the coolant is compressed by the high-pressure compressor 1a to a high temperature and a high pressure (about 120° C. and 11 MPa in the example of FIG. 6), cooled (about 30° C. in the example of FIG. 6) by passing through the first heat exchanger 2a via the coolant passage 11, further expanded isenthalpically by the cooling expansion valve V1a to a lower temperature (about 20° C. and 5 MPa in the example of FIG. 6), and supplied from the coolant passage 12 to the motor 4. The coolant supplied to the motor 4 cools the motor 4 by absorbing heat while passing through the stator, rotor, and bearings of the motor 4, returns to the high-pressure compressor 1a through the coolant passage 14 and the low-pressure coolant switching control valve V4c, and is compressed again.

In the thermal cycle circuit for performing cooling by the air conditioner 5, the coolant is compressed by the high-pressure compressor 1a to a high temperature and a high pressure (about 120° C. and 11 MPa in the example of FIG. 6, and a point A2 on the P-H diagram and the P-T diagram), cooled (about 30° C. in the example of FIG. 6, and a point A3 on the P-H diagram and the P-T diagram) by passing through the first heat exchanger 2a via the coolant passage 11, further expanded isenthalpically by the cooling expansion valve V1b to a lower temperature (about 20° C. and 5 MPa in the example of FIG. 6, and a point A4 on the P-H diagram and the P-T diagram), and supplied from the coolant passage 13b (example of the motor cooling path) to the air conditioner 5. The coolant supplied to the air conditioner 5 cools the air flowing into the vehicle cabin by absorbing heat while passing through the in-cabin heat exchanger of the air conditioner 5, returns to the high-pressure compressor la through the coolant passage 15 and the low-pressure coolant switching control valve V4c (about 30° C. and 5 MPa in the example of FIG. 6, and the point A1 on the P-H diagram and the P-T diagram), and is compressed again.

In the thermal cycle circuit for cooling the battery 6, the coolant after cooling the air conditioner 5 (about 30° C. and 5 MPa in the example of FIG. 6) is supplied via the coolant passage 16, the low-pressure coolant switching control valve V4a and the coolant passage 17 to the common rail V2a (about 30° C. and 5 MPa in the example of FIG. 6, and a point B1 on the P-H diagram and the P-T diagram). The coolant that has been pressure-accumulated in the common rail V2a is injected into the battery case 6a by the injectors V2b. At this time, the coolant is expanded to a lower temperature (about −60° C. and 0.1 MPa in the example of FIG. 6, and a point B2 on the P-H diagram and the P-T diagram) than the cells 6b, and the coolant injected into the battery case 6a cools the cells 6b by absorbing heat while flowing around the cells 6b, and then flows out of the battery case 6a through the coolant passage 18 (about 20° C. and 0.1 MPa in the example of FIG. 6, and a point B3 on the P-H diagram and the P-T diagram). Thereafter, the coolant is compressed by the low-pressure compressor 1b, returns to the high-pressure compressor 1a through the heat exchanger bypass control valve V3a, the coolant passage 20, the heat exchanger bypass control valve V3b, the low-pressure coolant switching control valve V4b, the coolant passage 22 and the low-pressure coolant switching control valve V4c, and is compressed again (about 120° C. and 11 MPa in the example of FIG. 6, and a point B4 on the P-H diagram and the P-T diagram).

### Air-Conditioning/Battery Coordinated Control Pattern 2-a

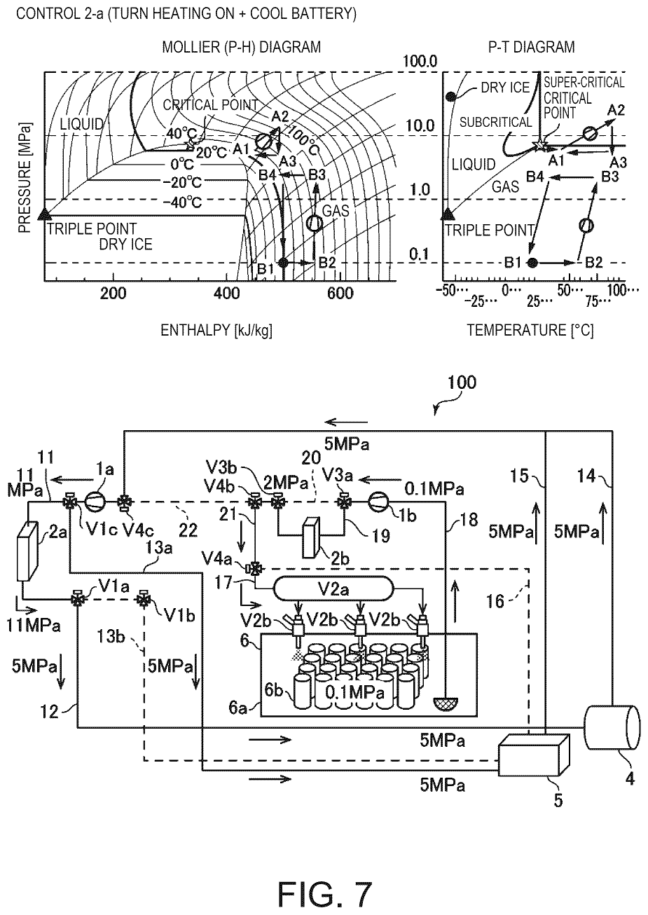

FIG. 7 is an explanatory view showing the P-H diagram and P-T diagram of the heating cycle of the air conditioner 5 and the cooling cycle of the battery 6, and the flow of the coolant in the air-conditioning/battery coordinated control pattern 2-a. As shown in FIG. 5, the air-conditioning/battery coordinated control pattern 2-a is an example of a control pattern when there is a heating request for the air conditioner 5 and a cooling request for the battery 6.

In the air-conditioning/battery coordinated control pattern 2-a, as shown in FIG. 7, a thermal cycle circuit for cooling the motor 4, a thermal cycle circuit for performing heating by the air conditioner 5, and a thermal cycle circuit for cooling the battery 6 independently of the air conditioner 5 are formed in the temperature adjustment system 100. Of these thermal cycle circuits, the thermal cycle circuit for cooling the motor 4 is the same as that in the air-conditioning/battery coordinated control pattern 1-a.

In the thermal cycle circuit for performing heating by the air conditioner 5, the coolant is compressed by the high-pressure compressor la to a high temperature and a high pressure (about 120° C. and 11 MPa in the example of FIG. 7, and the point A2 on the P-H diagram and the P-T diagram) and expanded by the temperature-increasing valve V1c, and the coolant having a higher temperature (about 60° C. and 5 MPa in the example of FIG. 7, and the point A3 on the P-H diagram and the P-T diagram) than the air in the vehicle cabin is supplied from the coolant passage 13a to the air conditioner 5. The coolant supplied to the air conditioner 5 cools the air flowing into the vehicle cabin by absorbing heat while passing through the in-cabin heat exchanger of the air conditioner 5, returns to the high-pressure compressor la through the coolant passage 15 and the low-pressure coolant switching control valve V4c (about 30° C. and 5 MPa in the example of FIG. 7, and the point A1 on the P-H diagram and the P-T diagram), and is compressed again.

In the thermal cycle circuit for cooling the battery 6, the coolant is compressed by the low-pressure compressor 1b to a high temperature and a high pressure (about 80° C. and 2 MPa in the example of FIG. 7, and the point B3 on the P-H diagram and the P-T diagram), cooled (about 30° C. and 2 MPa in the example of FIG. 7, and the point B4 on the P-H diagram and the P-T diagram) through the second heat exchanger 2b via the heat exchanger bypass control valve V3a and the coolant passage 19, and further supplied to the common rail V2a through the heat exchanger bypass control valve V3b, the low-pressure coolant switching control valve V4b, the coolant passage 21, the low-pressure coolant switching control valve V4a and the coolant passage 17. The coolant that has been pressure-accumulated in the common rail V2a is injected into the battery case 6a by the injectors V2b. At this time, the coolant is expanded to a lower temperature (about 20° C. and 0.1 MPa in the example of FIG. 7, and the point B1 on the P-H diagram and the P-T diagram) than the cells 6b, and the coolant injected into the battery case 6a cools the cells 6b by absorbing heat while flowing around the cells 6b, and then flows out of the battery case 6a through the coolant passage 18 (about 60° C. and 0.1 MPa in the example of FIG. 7, and the point B2 on the P-H diagram and the P-T diagram). Thereafter, the coolant returns to the low-pressure compressor 1b, and is compressed again.

### Air-Conditioning/Battery Coordinated Control Pattern 2-b

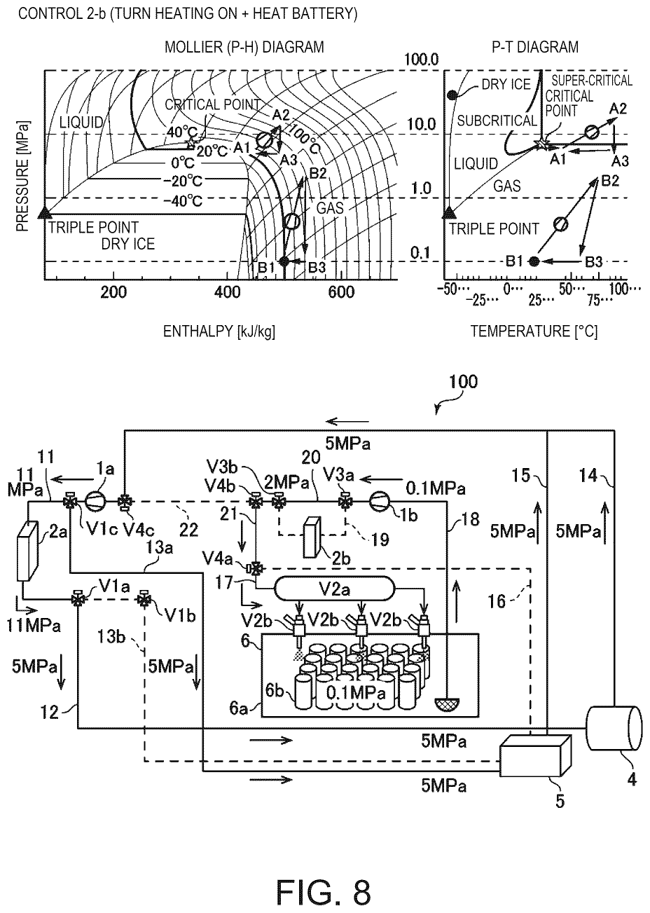

FIG. 8 is an explanatory view showing the P-H diagram and P-T diagram of the thermal cycles of the air conditioner 5 and the battery 6, and the flow of the coolant in the air-conditioning/battery coordinated control pattern 2-b. As shown in FIG. 5, the air-conditioning/battery coordinated control pattern 2-b is an example of a control pattern when there is a heating request for the air conditioner 5 and a heating request for the battery 6.

In the air-conditioning/battery coordinated control pattern 2-b, as shown in FIG. 8, a thermal cycle circuit for cooling the motor 4, a thermal cycle circuit for performing heating by the air conditioner 5, and a thermal cycle circuit for heating the battery 6 independently of the air conditioner 5 are formed in the temperature adjustment system 100. Of these thermal cycle circuits, the thermal cycle circuit for cooling the motor 4 is the same as that in the air-conditioning/battery coordinated control pattern 1-a, and the thermal cycle circuit for performing heating by the air conditioner 5 is the same as that in the air-conditioning/battery coordinated control pattern 2-a.

In the thermal cycle circuit for heating the battery 6, the coolant is compressed by the low-pressure compressor 1b to a high temperature and a high pressure (about 80° C. and 2 MPa in the example of FIG. 8, and the point B2 on the P-H diagram and the P-T diagram), and is supplied to the common rail V2a through the heat exchanger bypass control valve V3a, the coolant passage 20, the heat exchanger bypass control valve V3b, the low-pressure coolant switching control valve V4b, the coolant passage 21, the low-pressure coolant switching control valve V4a and the coolant passage 17. The coolant that has been pressure-accumulated in the common rail V2a is injected into the battery case 6a by the injectors V2b. At this time, although the coolant is expanded, the coolant has a higher temperature (about 60° C. and 0.1 MPa in the example of FIG. 8, and the point B3 on the P-H diagram and the P-T diagram) than the cells 6b, and the coolant injected into the battery case 6a dissipates heat while flowing around the cells 6b to heat the cells 6b, and then returns to the low-pressure compressor 1b through the coolant passage 18 (about 20° C. and 0.1 MPa in the example of FIG. 8, and the point B1 on the P-H diagram and the P-T diagram), and is compressed again.

### Air-Conditioning/Battery Coordinated Control Pattern 3-a

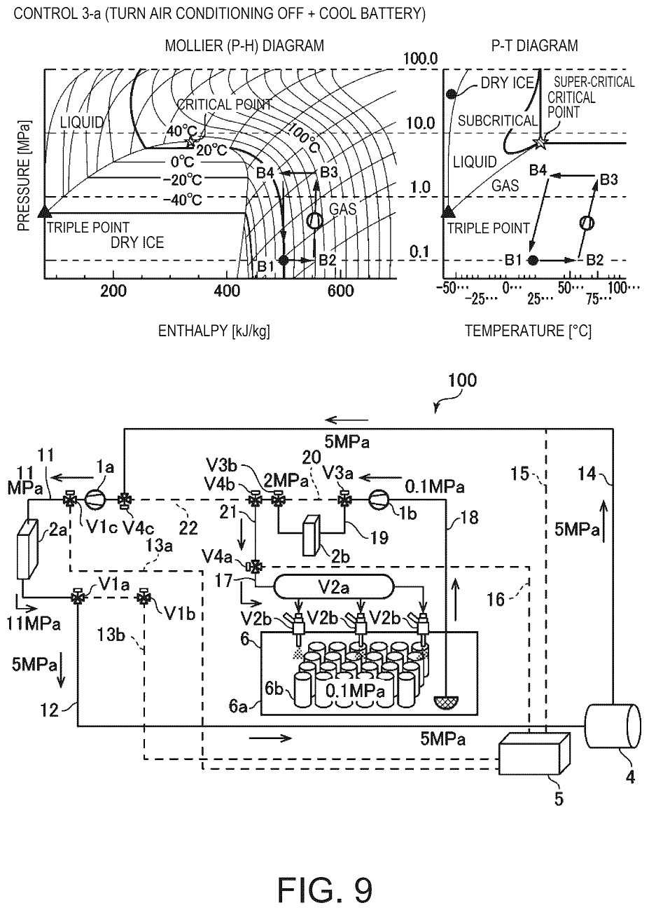

FIG. 9 is an explanatory view showing the P-H diagram and P-T diagram of the cooling cycle of the battery 6, and the flow of the coolant in the air-conditioning/battery coordinated control pattern 3-a. As shown in FIG. 5, the air-conditioning/battery coordinated control pattern 3-a is an example of a control pattern when there is no cooling/heating request for the air conditioner 5 (in other words, the air conditioner 5 is off) and there is a cooling request for the battery 6.

In the air-conditioning/battery coordinated control pattern 3-a, as shown in FIG. 9, a thermal cycle circuit for cooling the motor 4, and a thermal cycle circuit for cooling the battery 6 independently of the air conditioner 5 are formed in the temperature adjustment system 100. Of these thermal cycle circuits, the thermal cycle circuit for cooling the motor 4 is the same as that in the air-conditioning/battery coordinated control pattern 1-a, and the thermal cycle circuit for cooling the battery 6 is the same as that in the air-conditioning/battery coordinated control pattern 2-a.

### Air-Conditioning/Battery Coordinated Control Pattern 3-b

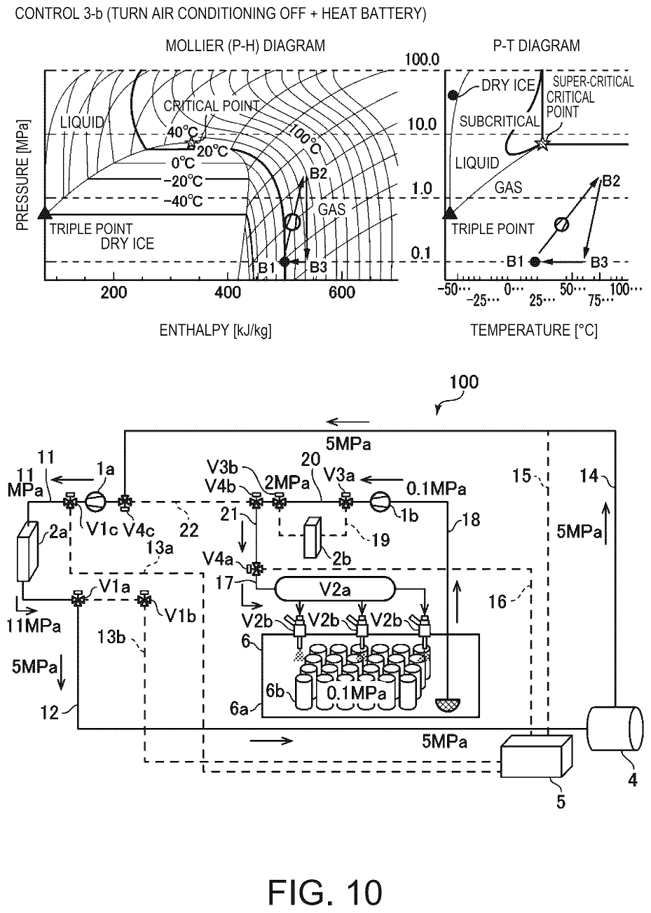

FIG. 10 is an explanatory view showing the P-H diagram and P-T diagram of the heating cycle of the battery 6 and the flow of the coolant in the air-conditioning/battery coordinated control pattern 3-b. As shown in FIG. 5, the air-conditioning/battery coordinated control pattern 3-b is an example of a control pattern when there is no cooling/heating request for the air conditioner 5 (in other words, the air conditioner 5 is off) and there is a heating request for the battery 6.

In the air-conditioning/battery coordinated control pattern 3-b, as shown in FIG. 10, a thermal cycle circuit for cooling the motor 4, and a thermal cycle circuit for heating the battery 6 independently of the air conditioner 5 are formed in the temperature adjustment system 100. Of these thermal cycle circuits, the thermal cycle circuit for cooling the motor 4 is the same as that in the air-conditioning/battery coordinated control pattern 1-a, and the thermal cycle circuit for heating the battery 6 is the same as that in the air-conditioning/battery coordinated control pattern 2-b.

### Air-Conditioning/Battery Coordinated Control Pattern 4-a

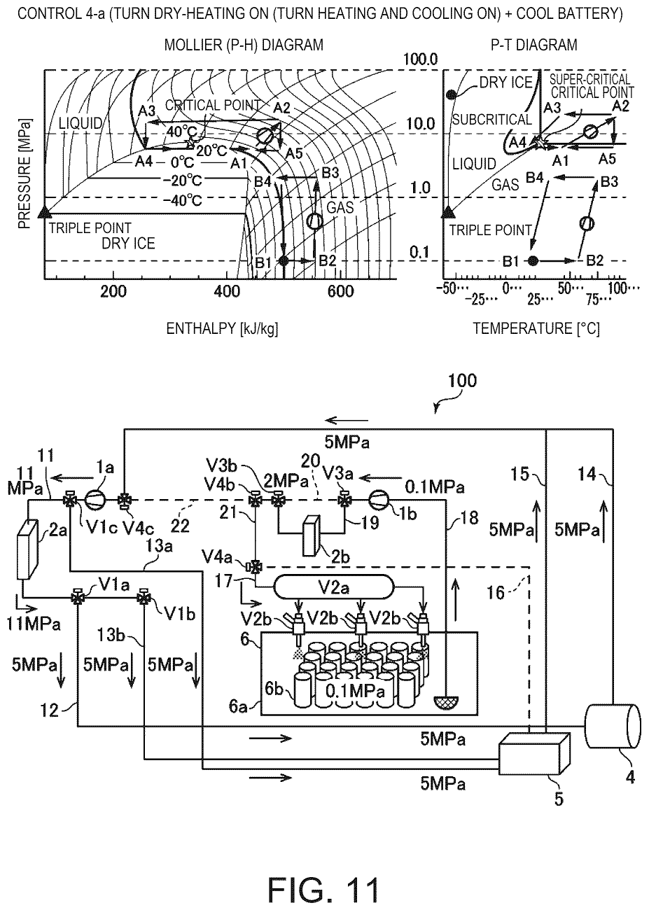

FIG. 11 is an explanatory view showing the P-H diagram and P-T diagram of the heating and cooling cycle of the air conditioner 5 and the cooling cycle of the battery 6, and the flow of the coolant in the air-conditioning/battery coordinated control pattern 4-a. As shown in FIG. 5, the air-conditioning/battery coordinated control pattern 4-a is an example of a control pattern when there are a dry-heating request for the air conditioner 5 and a cooling request for the battery 6. In the present embodiment, the term “dry-heating” means an operation in which cooling and heating are performed simultaneously to perform heating while dehumidifying the air in the vehicle cabin.

In the air-conditioning/battery coordinated control pattern 4-a, as shown in FIG. 11, a thermal cycle circuit for cooling the motor 4, a thermal cycle circuit for performing dry-heating by the air conditioner 5, and a thermal cycle circuit for cooling the battery 6 independently of the air conditioner 5 are formed in the temperature adjustment system 100. Of these thermal cycle circuits, the thermal cycle circuit for cooling the motor 4 is the same as that in the air-conditioning/battery coordinated control pattern 1-a, and the thermal cycle circuit for cooling the battery 6 is the same as that in the air-conditioning/battery coordinated control pattern 2-a.

In the thermal cycle circuit for performing dry-heating by the air conditioner 5, the coolant is compressed by the high-pressure compressor 1a to a high temperature and a high pressure (about 120° C. and 11 MPa in the example of FIG. 11, and the point A2 on the P-H diagram and the P-T diagram). A portion of the high-temperature, high-pressure coolant is cooled (about 30° C. in the example of FIG. 11, and the point A3 on the P-H diagram and the P-T diagram) through the first heat exchanger 2a via the coolant passage 11, further expanded isenthalpically by the cooling expansion valve V1b to a lower temperature (about 20° C. and 5 MPa in the example of FIG. 11, and the point A4 on the P-H diagram and the P-T diagram), and supplied from the coolant passage 13b to the air conditioner 5. The coolant supplied to the air conditioner 5 absorbs heat while passing through a dehumidifying heat exchanger of the air conditioner 5 to dehumidify the air flowing into the vehicle cabin, and returns via the coolant passage 15 and the low-pressure coolant switching control valve V4c to the high-pressure compressor 1a (about 30° C. and 5 MPa in the example of FIG. 11, and the point A1 in the P-H diagram and the P-T diagram). Further, a portion of the high-temperature, high-pressure coolant that is not used for dehumidification is expanded by the temperature-increasing valve V1c (about 60° C. and 5 MPa in the example of FIG. 11, and a point A5 on the P-H diagram and the P-T diagram), and supplied from the coolant passage 13a to the air conditioner 5. The coolant supplied to the air conditioner 5 dissipates heat while passing through the in-cabin heat exchanger of the air conditioner 5 to heat the air flowing into the vehicle cabin, returns through the coolant passage 15 and the low-pressure coolant switching control valve V4c to the high-pressure compressor 1a (about 30° C. and 5 MPa in the example of FIG. 11, and the point A1 in the P-H diagram and the P-T diagram), and is compressed again together with the coolant used for dehumidification.

### Air-Conditioning/Battery Coordinated Control Pattern 4-b

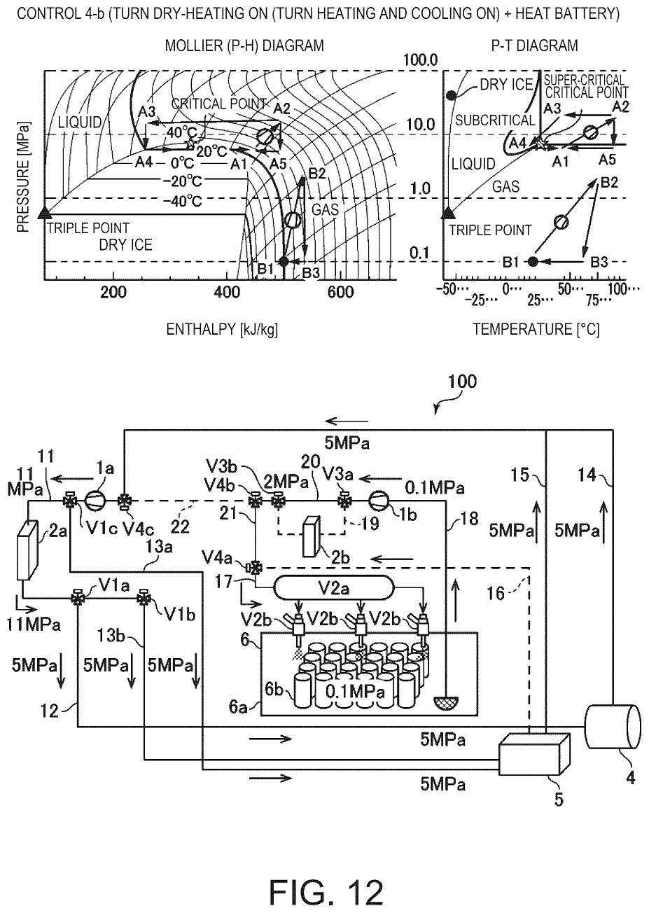

FIG. 12 is an explanatory view showing the P-H diagram and P-T diagram of the heating and cooling cycle of the air conditioner 5 and the heating cycle of the battery 6, and the flow of the coolant in the air-conditioning/battery coordinated control pattern 4-b. As shown in FIG. 5, the air-conditioning/battery coordinated control pattern 4-b is an example of a control pattern when there are a dry-heating request for the air conditioner 5 and a heating request for the battery 6.

In the air-conditioning/battery coordinated control pattern 4-b, as shown in FIG. 12, a thermal cycle circuit for cooling the motor 4, a thermal cycle circuit for performing dry-heating by the air conditioner 5, and a thermal cycle circuit for heating the battery 6 independently of the air conditioner 5 are formed in the temperature adjustment system 100. Of these thermal cycle circuits, the thermal cycle circuit for cooling the motor 4 is the same as that in the air-conditioning/battery coordinated control pattern 1-a, the thermal cycle circuit for performing dry-heating by the air conditioner 5 is the same as that in the air-conditioning/battery coordinated control pattern 4-a, and the thermal cycle circuit for heating the battery 6 is the same as that in the air-conditioning/battery coordinated control pattern 2-b.

### Functions and Effects

Next, functions and effects of the temperature adjustment system for the electric vehicle of the present embodiment and of a modification will be described.

According to the temperature adjustment system 100 of the present embodiment, since the cooling of the air conditioner 5, the cooling of the motor 4, and the cooling of the battery 6 are performed using the shared coolant containing CO₂, the overall configuration of the temperature adjustment system 100 can be made compact. Moreover, when cooling the air conditioner 5 and cooling the battery 6, since the coolant after cooling the air conditioner 5 is supplied to the common rail V2a and the injectors V2b and further expanded and injected into the battery case 6a from the injectors V2b, the cells 6b can be directly cooled by the coolant while maintaining the strength of the structures of the cells 6b and the battery case 6a of the battery 6 at the same level as before. Consequently, it is possible to perform the temperature adjustment of the battery 6 with high responsiveness, without causing an increase in the weight of the battery 6 or a rise in manufacturing costs.

Further, since the coolant that has been compressed by the low-pressure compressor 1b after passing through the battery 6, the coolant that has passed through the air conditioner 5, and the coolant that has passed through the motor 4 can all be compressed by the high-pressure compressor 1a, the second compressor can be shared to compress the coolant used for cooling the air conditioner 5, the motor 4, and the battery 6, and the overall configuration of the temperature adjustment system 100 can be made compact.

Furthermore, by expanding and injecting the high-temperature, high-pressure coolant compressed by the low-pressure compressor 1b into the battery case 6a from the injectors V2b, it is possible to directly heat the cells 6b by the coolant. Consequently, it is possible to perform the temperature adjustment of the battery 6 with high responsiveness, without causing the increase in the weight of the battery 6 or the rise in manufacturing costs.

Moreover, the coolant that has passed through the battery 6 is compressed by the low-pressure compressor 1b, further cooled by the second heat exchanger 2b, and supplied to the common rail V2a and the injectors V2b via the heat exchanger bypass control valve V3b, the low-pressure coolant switching control valve V4b, the coolant passage 21, the low-pressure coolant switching control valve V4a and the coolant passage 17, and then expanded and injected into the battery case 6a from the injectors V2b, and, therefore, even when the air conditioner 5 is heating or off and the coolant after cooling the air conditioner 5 cannot be used, it is possible to directly cool the cells 6b by the coolant flowing through the thermal cycle circuit independent of the air conditioner 5. Consequently, it is possible to perform the temperature adjustment of the battery 6 with high responsiveness, without causing the increase in the weight of the battery 6 or the rise in manufacturing costs.

Further, since a necessary amount of the coolant corresponding to the heat generation amount and the temperature of the battery 6 can be highly accurately injected at an appropriate pressure into the battery case 6a from the injectors V2b, it is possible to curb temperature fluctuations of the cells 6b of the battery 6 and reduce deterioration of the battery 6 due to thermal cycles.

Furthermore, by supplying the high-temperature, high-pressure coolant compressed by the high-pressure compressor 1a to the air conditioner 5 via the coolant passage 13a, it is possible to perform heating of the air conditioner 5.

### Modification

In the above-described embodiment, when cooling the air conditioner 5 and cooling the battery 6 (air-conditioning/battery coordinated control pattern 1-a), the coolant after cooling the air conditioner 5 is supplied to the common rail V2a and injected into the battery case 6a by the injectors V2b, and, when cooling the battery 6 when the air conditioner 5 is heating or off (air-conditioning/battery coordinated control patterns 2-a, 3-a, 4-a), the coolant circulates in the thermal cycle circuit for cooling the battery 6 independently of the air conditioner 5, but the temperature adjustment system 100 may be configured differently. For example, the temperature adjustment system 100 may be configured such that, regardless of an air conditioning request for the air conditioner 5, when cooling the battery 6, the coolant is compressed by the high-pressure compressor la and cooled by passing through the first heat exchanger 2a, and further, the coolant is expanded isenthalpically by the cooling expansion valve V1b to a lower temperature (for example, about 20° C. and 5 MPa), supplied to the common rail V2a, and injected into the battery case 6a by the injectors V2b to expand to 0.1 MPa, for example, and cool the cells 6b. In this case, the temperature adjustment system 100 may also be configured such that a coolant passage is formed on the outside of the battery case 6a (typically on a surface of the case), and the high-temperature, high-pressure coolant (for example, about 120° C. and 11 MPa) after compressed by the high-pressure compressor 1a is passed through the coolant passage to indirectly heat the cells 6b in the battery case 6a by the coolant.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims. Further, if used herein, a phrase of the form “at least one of A and B” means at least one A or at least one B, without being mutually exclusive of each other, and does not require at least one A and at least one B. If used herein, the phrase “and/or” means either or both of two stated possibilities.

### REFERENCE CHARACTER LIST

1 Compressor
1a High-pressure compressor
1b Low-pressure compressor
2 Heat exchanger
2a First heat exchanger 2b Second heat exchanger
4 Motor
5 Air conditioner
6 Battery
6a Battery case
6b Cell
11-22 Coolant passage
31 Coolant temperature sensor
32 Coolant pressure sensor
33 Battery temperature sensor
34 Motor temperature sensor
35 Inside and outside air temperature sensor
36 Air conditioning switch
40 Control device
100 Temperature adjustment system
200 Electric vehicle
V1a, V1b Cooling expansion valve
V1c Temperature-increasing valve
V2a Common rail
V2b Injector
V3a, V3b Heat exchanger bypass control valve
V4a, V4b, V4c Low-pressure coolant switching control valve

1. A temperature adjustment system for an electric vehicle comprising an air conditioning unit for performing air conditioning, a drive motor, and a battery having a cell accommodated in a battery case, the temperature adjustment system comprising:
a compressor for compressing a coolant containing CO₂;
a first heat exchanger for cooling the coolant compressed by the compressor;
a first expansion valve for expanding the coolant cooled by the first heat exchanger;
an air-conditioning cooling path for supplying the coolant expanded by the first expansion valve to the air conditioning unit when cooling the air conditioning unit;
a motor cooling path for supplying the coolant expanded by the first expansion valve to the motor when cooling the motor;
a second expansion valve for expanding and injecting the coolant into the battery case;
a first battery cooling path for supplying the coolant after cooling the air conditioning unit to the second expansion valve when cooling the air conditioning unit and cooling the battery; and
a recovery path for supplying, to the compressor, the coolant that has passed through the air conditioning unit, the coolant that has passed through the motor, and the coolant that has passed through the battery.

2. The temperature adjustment system according to claim 1, wherein
the compressor includes:
a first compressor for compressing the coolant that has passed through the battery; and
a second compressor for compressing the coolant that has passed through the air conditioning unit and the coolant that has passed through the motor, and
when cooling the air conditioning unit and cooling the battery, the second compressor further compresses the coolant that has been compressed by the first compressor.

3. The temperature adjustment system according to claim 2, further comprising a battery heating path for supplying the coolant compressed by the first compressor to the second expansion valve when heating the battery.

4. The temperature adjustment system according to claim 2, further comprising:
a second heat exchanger that, when cooling the battery when the air conditioning unit is heating or off, cools the coolant compressed by first the compressor; and
a second battery cooling path that, when cooling the battery when the air conditioning unit is heating or off, supplies the coolant cooled by the second heat exchanger to the second expansion valve.

5. The temperature adjustment system according to claim 3, further comprising:
a second heat exchanger that, when cooling the battery when the air conditioning unit is heating or off, cools the coolant compressed by first the compressor; and
a second battery cooling path that, when cooling the battery when the air conditioning unit is heating or off, supplies the coolant cooled by the second heat exchanger to the second expansion valve.

6. The temperature adjustment system according to claim 1, wherein the second expansion valve has a common rail for accumulating the coolant, and an injector for injecting the coolant accumulated in the common rail into the battery case.

7. The temperature adjustment system according to claim 2, wherein the second expansion valve has a common rail for accumulating the coolant, and an injector for injecting the coolant accumulated in the common rail into the battery case.

8. The temperature adjustment system according to claim 3, wherein the second expansion valve has a common rail for accumulating the coolant, and an injector for injecting the coolant accumulated in the common rail into the battery case.

9. The temperature adjustment system according to claim 4, wherein the second expansion valve has a common rail for accumulating the coolant, and an injector for injecting the coolant accumulated in the common rail into the battery case.

10. The temperature adjustment system according to claim 5, wherein the second expansion valve has the common rail for accumulating the coolant, and the injector for injecting the coolant accumulated in the common rail into the battery case.

11. The temperature adjustment system according to claim 1, further comprising an air-conditioning heating path for supplying the coolant compressed by the compressor to the air conditioning unit when heating the air conditioning unit.

12. The temperature adjustment system according to claim 2, further comprising an air-conditioning heating path for supplying the coolant compressed by the compressor to the air conditioning unit when heating the air conditioning unit.

13. The temperature adjustment system according to claim 3, further comprising an air-conditioning heating path for supplying the coolant compressed by the compressor to the air conditioning unit when heating the air conditioning unit.

14. The temperature adjustment system according to claim 4, further comprising an air-conditioning heating path for supplying the coolant compressed by the compressor to the air conditioning unit when heating the air conditioning unit.

15. The temperature adjustment system according to claim 5, further comprising an air-conditioning heating path for supplying the coolant compressed by the compressor to the air conditioning unit when heating the air conditioning unit.

16. A method for controlling a temperature adjustment system for an electric vehicle comprising an air conditioning unit for performing air conditioning, a drive motor, and a battery having a cell accommodated in a battery case, the temperature adjustment system comprising a compressor for compressing a coolant containing CO₂, a first heat exchanger for cooling the coolant compressed by the compressor, a first expansion valve for expanding the coolant cooled by the first heat exchanger, and a second expansion valve for expanding and injecting the coolant into the battery case, the method comprising:
in response to obtaining a cooling request, supplying the coolant expanded by the first expansion valve to the air conditioning unit via an air-conditioning cooling path for cooling the air conditioning unit;
in response to obtaining a motor cooling request, supplying the coolant expanded by the first expansion valve to the motor via a motor cooling path for cooling the motor;
in response to obtaining a battery temperature adjustment request and the cooling request, supplying the coolant after cooling the air conditioning unit to the second expansion valve via a first battery cooling path for cooling the battery while cooling the air conditioning unit; and
supplying the coolant that has passed through the air conditioning unit, the coolant that has passed through the motor, and/or the coolant that has passed through the battery to the compressor via a recovery path.

17. The method according to claim 16, wherein
the compressor includes a first compressor for compressing the coolant that has passed through the battery, and a second compressor for compressing the coolant that has passed through the air conditioning unit and the coolant that has passed through the motor, and
the method further comprises, in response to obtaining the battery temperature adjustment request and the cooling request, further compressing the coolant that has been compressed by the first compressor, via the second compressor.

18. The method according to claim 16, further comprising, in response to obtaining the battery temperature adjustment request, supplying the coolant compressed by the first compressor to the second expansion valve via a battery heating path for heating the battery.

19. The method according to claim 16, wherein the second expansion valve has a common rail for accumulating the coolant, and an injector for injecting the coolant accumulated in the common rail into the battery case.

20. The method according to claim 16, further comprising, in response to obtaining a heating request, supplying the coolant compressed by the compressor to the air conditioning unit via an air-conditioning heating path for heating the air conditioning unit.
